(19) United States
(12) Patent Application Publication
(10) Pub. No.: US 2006/0134354 A1
(43) Pub. Date: Jun. 22, 2006

(54) Calibration vial stopper with improved security features

(76) Inventors: Jay Mark Walters, New London, PA (US); Peter Louis Gebrian, Wilmington, DE (US); Jens Geisel, Munchhausen-Niederasphe (DE)

Correspondence Address: Robert N. Carpenter;Dade Behring Inc., P.O. Box 778, 1717 Deerfield Road, Deerfield, IL, 60015-0778, US

(21) Appl. No.: 11/013,588

(22) Filed: Dec. 16, 2004

(51) Int. Cl. B31B 45/00

(52) U.S. Cl. 428/34.1

(57) ABSTRACT

A re-sealing puncturable stopper for use with capped vials having lyophilized calibration chemicals therein adapted for use in a manner that minimizes failure modes: (1) in an initial lyophilization manufacturing process; (2) during a subsequent hydration process; (3) while protecting a vial stored on-board an automated clinical analyzer; (4) when punctured for aspiration; and, (5) when re-sealing the vial after aspiration.

### FIELD OF THE INVENTION

The present invention relates to an apparatus for automatically processing a patient's biological fluids such as urine, blood serum, plasma, cerebrospinal fluid and the like. More particularly, the present invention relates to a stopper closure for calibration vials involved in performing quality control procedures within an automated biochemical analyzer adapted for analyzing biological fluids.

### BACKGROUND OF THE INVENTION

Biochemical analyzers are well known and almost universally employ some sort of a calibration curve that relates analyte concentration within a carefully prepared solution having a known analyte concentration against the signal generated by the reaction monitoring means in response to the presence of the analyte. Such solutions are called “calibrators” or “calibration solutions” or “standard solutions” and are contained in vial-like containers closed with a stopper of some sort. It is regular practice within the biochemical analytical industry to establish a full calibration curve for a chemical analyzer by using multiple calibration solutions or calibrators which have been carefully prepared with known, predetermined concentrations of analyte. These calibration or standard solutions are assayed one or more times and the mean resulting reaction signals are plotted versus their respective known analyte concentrations. A continuous calibration curve is then produced using any of several mathematical techniques chosen to produce an accurate replication of the relationship between a reaction signal and the analyte concentration. The shape of the calibration curve is affected by a complex interaction between reagents, analyte and the analyzer's electromechanical design. Thus, even if the theoretical analyte-reagent reaction is known, it is generally necessary to employ mathematical techniques to obtain an acceptable calibration curve. The range of analyte concentrations used in establishing a full calibration curve is typically chosen to extend below and beyond the range of analyte concentrations expected to be found within biological samples like blood, serum, plasma, urine and the like.

Problematically, certain calibration solutions employed in the industry have an undesirably short useful life time during which the solution remains stable and thus are supplied in a more stable powdered form rather than in a less stable liquid form. Prior to being placed on an analyzer, a vial containing a powdered or lyophilized calibration solution is opened by an operator, rehydrated using a precise amount of distilled or de-ionized water, the vial is re-closed, shaken to dissolve all powdered calibrator and placed on the analyzer. The contents of the test cuvette are then assayed by the analyzer and the results used to either confirm that the analyzer is in proper calibration condition or the results may be used to adjust the analyzer's calibration curves to achieve a proper calibration condition.

In order that calibration solutions, whether originally supplied in liquid form or in powdered form and rehydrated, be securely contained during shipping and handling, calibration vials are typically closed using a screw threaded plastic or hard rubber cap with an open hole in the center portion and an elastomeric stopper filling the hole. When it is desired to extract a portion of the solution from the vial, the solution is extracted by an operator using, for example, a syringe with a sharpened probe suited to penetrate the stopper. Similarly, if the calibration solutions are inventoried on-board the analyzer in a controlled environment, like described in co-pending U.S. patent Ser. No. 10/123,456 assigned to the assignee of the present invention, an automated probe may be used to extract a portion of the solution from the vial as part of automated calibration and quality control protocols.

In the instance that a vial containing a lyophilized calibration solution is opened by an operator, and rehydrated, it is possible that the vial may be accidentally or improperly closed using only the elastomeric stopper and placed on the analyze without securing the stopper in the vial by screwing the cap onto threads' on the vial. During running of the analyzer, or when the stopper is penetrated by an automated probe, such an elastomeric stopper may be dislodged and fall into the analyzer presenting a hazard to continued operation. Alternately, the stopper may stick onto the probe and prevent a next scheduled aspiration or probe cleaning causing analyzer operation to be disrupted.

It may seem that such a hazard could be eliminated using an integrated stopper and plastic screw cap. However lyophilized calibration solutions are produced in a freeze-drying operation in which an original liquid calibration solution in an open vial is exposed to high vacuum and the vial must be closed while still under vacuum. This is most efficiently done using a vertical downwards motion to simultaneously insert a large number of stoppers into an array of lyophilization vials. If the stopper were integrated with the cap, a more complex and costly rotary motion would be required to screw the caps onto the vials in order to close the vials with the stopper.

### SUMMARY OF THE INVENTION

The principal object of the invention is to provide a re-sealing puncturable stopper-for use with capped vials having lyophilized calibration chemicals therein. The stopper of the present invention is adapted for use in a manner that minimizes failure modes: (1) in an initial lyophilization manufacturing process; (2) by a user in a subsequent hydration process; (3) protecting a vial stored on-board an automated clinical analyzer; (4) being punctured for aspiration; and, (5) re-sealing the vial after aspiration. An opened section in the stopper's lower portion allows the stopper to be partly inserted into the upper portion of the vial so that the vial's original liquid contents may be exposed to vacuum during a lyophilization operation. After the lyophilization process is completed, the vial may be closed in a multiple-vial closing operation simply by vertically pushing downwards on an array of stoppers until they are fully inserted into the vials. Subsequent to closing the vials, conventional threaded caps may be attached to the vials by placing an open hole in the cap over a sloped top portion of the stopper and twisting the cap over the stopper until the cap slips into a groove in the stopper, thereby securing the cap and stopper combination. Prior to the lyophilized calibration solution being used on an analyzer, an operator unscrews the cap-stopper combination, hydrates the chemicals as required, replaces the cap-stopper combination and places the calibration vial on-board the analyzer. The open hole in the cap exposes a central portion of the stopper which an aspiration probe can puncture during an aspiration process. The stopper is made of an elastomeric material that reseals the puncture to protect the contents of the vial while it remains stored in inventory upon the analyzer. An important feature of the cap-stopper combination is the securing groove that effectively integrates the cap and stopper together so that operational errors arising from the failure to properly replace and secure a stopper onto a calibration vial after hydration are minimized.

### BRIEF DESCRIPTION OF THE DRAWINGS

The invention will be more fully understood from the following detailed description thereof taken in connection with the accompanying drawings which form a part of this application and in which:

FIG. 1 is a schematic plan view of an automated analyzer adapted to perform the present invention;

FIG. 2 is an enlarged schematic plan view of a portion of the analyzer of FIG. 1;

FIG. 3 is a perspective view of a reagent container useful in the analyzer of FIG. 1;

FIG. 4A is a perspective view of a calibration and control solution vial rack useful in the analyzer of FIG. 1;

FIG. 4B is a top plan view of the calibration and control solutions vial rack of FIG. 4A;

FIG. 5 is a schematic plan view of a calibration and quality control solution vial management system useful in the analyzer of FIG. 1;

FIG. 6 is a front perspective view of a calibration and quality control solution vial stopper of the present invention;

FIG. 7 is a side view of the calibration and quality control solution vial stopper of FIG. 6;

FIG. 7A is a section view of the calibration and quality control solution vial stopper of FIG. 7 along line 7A-7A;

FIG. 7B is a section view of the calibration and quality control solution vial stopper of FIG. 7 along line 7B-7B;

FIG. 8 is a back view of the calibration and quality control solution vial stopper of FIG. 6;

FIG. 8A is a section view of the calibration and quality control solution vial stopper of FIG. 8 along line 8A-8A;

FIG. 9 is the section view of FIG. 8A illustrating the calibration and quality control solution vial stopper of the present invention during lypholization;

FIG. 10 is the section view of FIG. 9 of the quality control solution vial stopper of the present invention closed with a threaded cap;

FIG. 10A is a section view of the threaded cap of FIG. 10; and,

FIG. 10B is a top plan view of the threaded cap of FIG. 10.

### DETAILED DESCRIPTION OF THE INVENTION

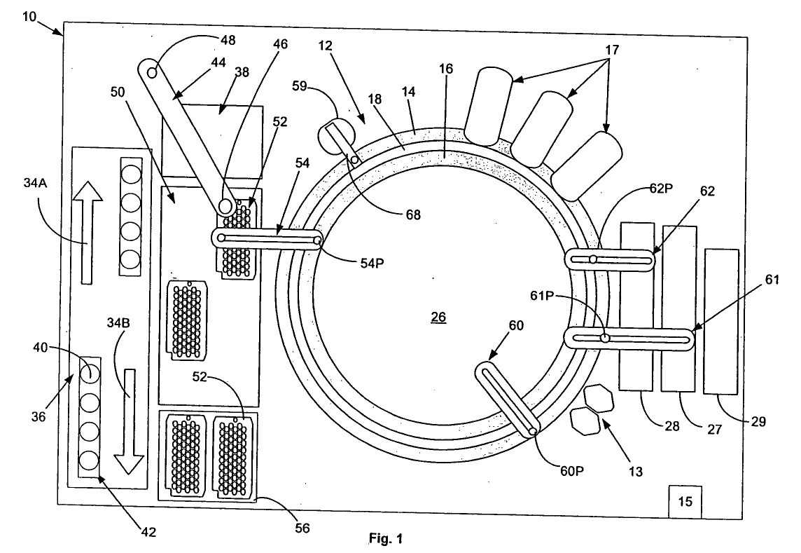

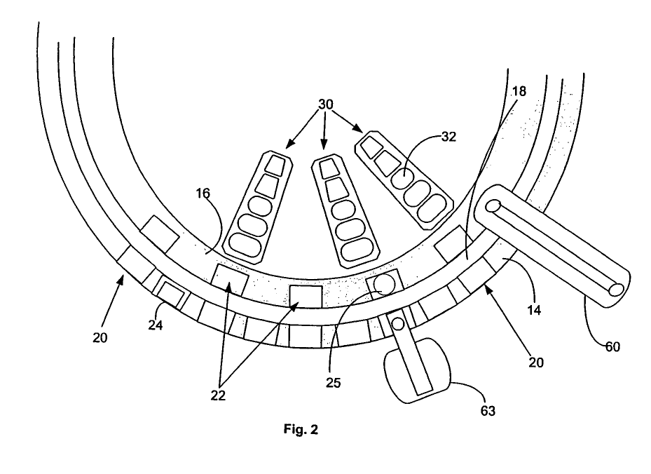

FIG. 1, taken with FIG. 2, shows schematically the elements of an automatic chemical analyzer 10 in which the present invention may be advantageously practiced, analyzer 10 comprising a reaction carousel 12 supporting an outer cuvette carousel 14 having cuvette ports 20 formed therein and an inner cuvette carousel 16 having vessel ports 22 formed therein, the outer cuvette carousel 14 and inner cuvette carousel 16 being separated by a open groove 18. Cuvette ports 20 are adapted to receive a plurality of reaction cuvettes 24 that contain various reagents and sample liquids for conventional clinical and immunoassay assays while vessel ports 22 are adapted to receive a plurality of reaction vessels 25 that contain specialized reagents for ultra-high sensitivity luminescent immunoassays. Reaction carousel 12 is rotatable using stepwise movements in a constant direction, the stepwise movements being separated by a constant dwell time during which carousel 12 is maintained stationary and computer controlled assay operational devices 13, such as sensors, reagent add stations, mixing stations and the like, operate as needed on an assay mixture contained within a cuvette 24.

Analyzer 10 is controlled by software executed by the computer 15 based on computer programs written in a machine language like that used on the Dimension® clinical chemistry analyzer sold by Dade Behring Inc, of Deerfield, Ill., and widely used by those skilled in the art of computer-based electromechanical control programming. Computer 15 also executes application software programs for performing assays conducted by various analyzing means 17 within analyzer 10.

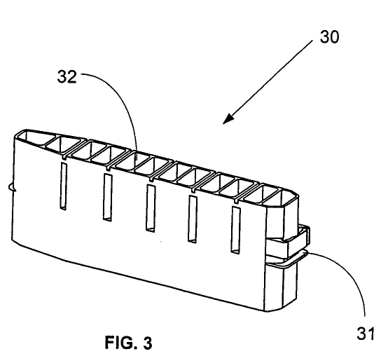

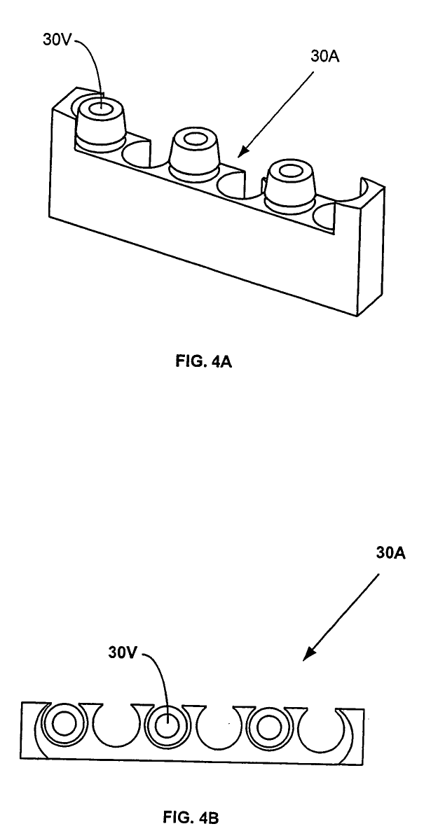

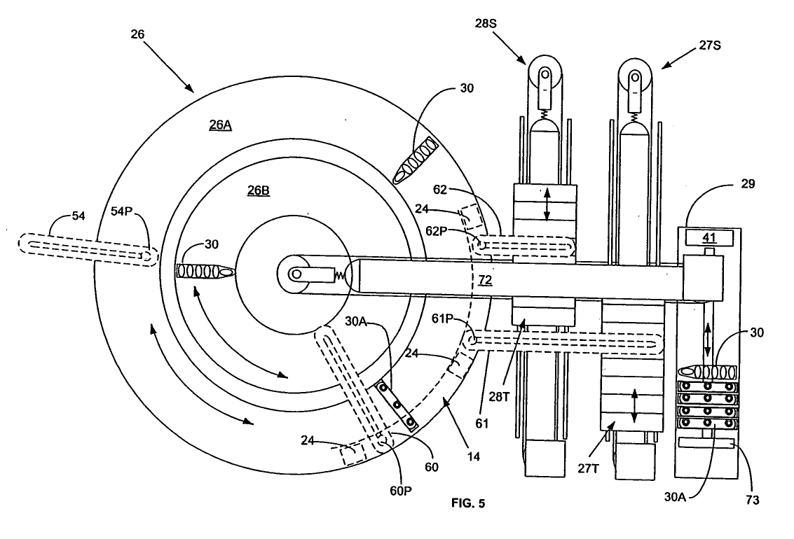

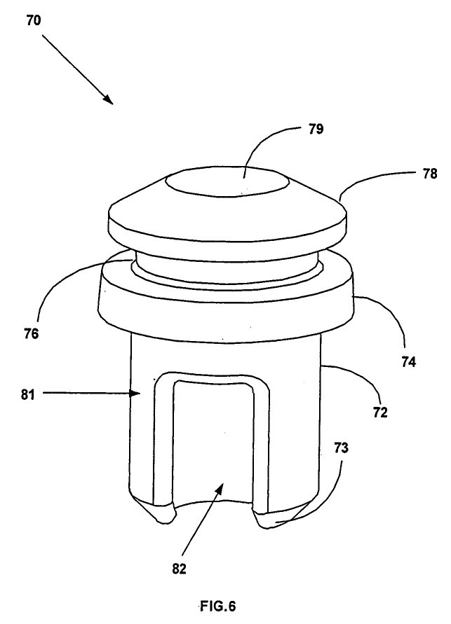

Temperature-controlled storage areas or servers 26, 27 and 28 store a plurality of multi-compartment elongate reagent cartridges 30 like that illustrated in FIG. 3 and described in co-pending application Ser. No.: 09/949,132 assigned to the assignee of the present invention, cartridges 30 containing reagents in wells 32 as necessary to perform a given assay. Server 26, also stores calibration and quality control solution vial racks 30A like seen in FIG. 4A and 4B having calibration or quality control solutions in vials 30V to be used in calibration and quality control procedures by analyzer 10. In a particularly useful embodiment, shown in FIG. 5, server 26 comprises a first carousel 26A in which reagent cartridges 30 may be inventoried until translated to a second carousel 26B for access by an aspiration and dispense arm 60. In this embodiment, vial racks 30A are inventoried in carousel 26A for access by an aspiration and dispense arm 54. FIG. 5 shows how in this embodiment, carousel 26A and carousel 26B are circular and concentric, the first carousel 26A being outwards of the second carousel 26B. Reagent containers 30 and vial racks 30A may be loaded by an operator by placing such containers 30 or racks 30A into a loading tray 29 adapted to automatically translate containers 30 and racks 30A to a shuttling position in carousel 26A. As indicated by the double-headed arc-shaped arrows, carousel 26A may be rotated in both directions so as to place any particular one of the vial racks 30A disposed thereon beneath aspiration and dispense arm 54.

A key factor in maintaining an optimum assay throughput within analyzer 10 is the ability to timely supply calibration and quality control solutions in vials 30V so that calibration and control procedures may be conducted as required, whether this be based on the basis of time between calibrations or number of assays performed since an immediately previous calibration or number of assay results outside normal ranges, or changes in the performance of the analyzer. This challenge may be met by timely equipping analyzer 10 with additional requisite calibration and quality control solutions used in calibration and control procedures, thereby maintaining assay throughput of analyzer 10 uninterrupted.

It is known in the industry that the so-called shelf-life of certain calibration and control chemical solutions, shelf-life being the length of time a chemical solution may be stored in a controlled environment and retain its chemical properties within its specified useful range, is too short for the solution to be stored in liquid form. For example, the chemical properties of a solution may drift outside its specified useful range in less than one month while that normal manufacturing inventory and delivery times exceed one month. One approach commonly taken in such instances is to freeze-dry or lyophilize the calibration solution; this however introduces the necessity for an operator to hydrate the lyophilized solution. Regardless of how carefully this is done by an operator, human errors will ultimately occur and some of these may have very adverse effects.

Typically, the cap used during a manufacturing process to close a calibration solution vial 30V after the solution therein is lyophilized is not integral with the stopper used by an operator to close that same calibration solution vial 30V after hydration of the lyophilized calibration solution therein. For example, a closed cap is normally used. For reasons of manufacturing efficiencies, simultaneous closing of large numbers of lyophilized calibration solution vials is desired and this usually leads to a crimping or stoppering closing process as opposed to a threaded-cap-like closing process. In contrast, for operator convenience, a threaded-cap-like threading process is generally preferred to securely close a calibration solution vial 30V after hydration. In addition, after hydration, a puncturable cover is preferably used to close calibration solution vial 30V in order to facilitate aspiration of the calibration solution by a device like probe 54P. As indicated earlier, it is important that the cap and stopper be secured together so that operational errors arising from the failure to properly replace and secure a stopper onto a calibration vial after hydration are minimized.

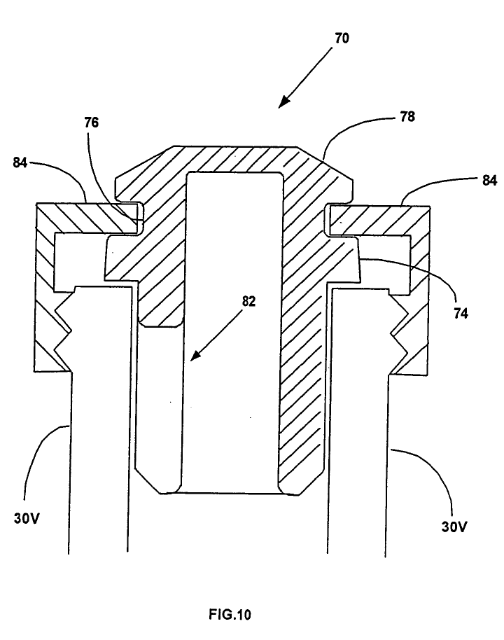

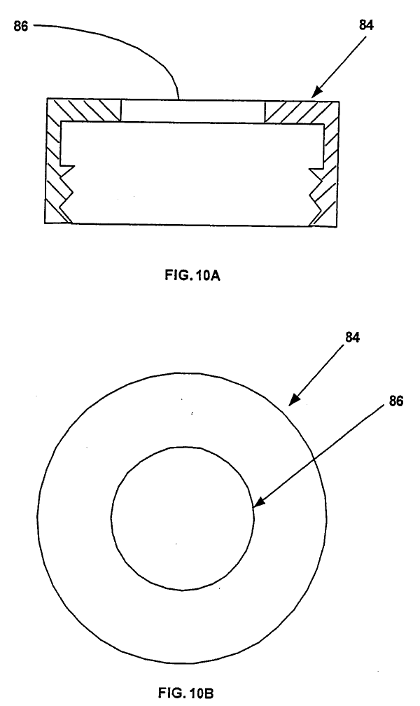

The present invention addresses these multiple needs by providing a re-sealing puncturable stopper associated with a cap adapted so that the stopper and cap may be used in combination in an initial lyophilization manufacturing process, by a user in a subsequent hydration process, stored safely on-board an automated clinical analyzer, and punctured for aspiration in a manner that minimizes failure modes. FIG. 6 is a front perspective view of the puncturable, resealable stopper 70 of the present invention having a generally vertically elongate shape with a cylindrical lower trunk section 72 sized to fit into and seal the top opening of calibration vial 30V. To facilitate fitting stopper 70 into a vial 30V, the outer bottom portion of trunk section 72 is sloped slightly inwards forming a bottom taper 73. A circular ridge 74 at the top of trunk section 72 stops trunk section 72 from being pushed further into vial 30V and a groove 76 is formed above ridge 74, groove 76 being sized to fit within an opening 86 in the top of a conventional threaded cap as seen in FIG. 10. In an exemplary embodiment, ridge 74 is functional to prevent stopper 70 from being fully inserted into vial 30V as well as to seal stopper 70 onto into vial 30V.

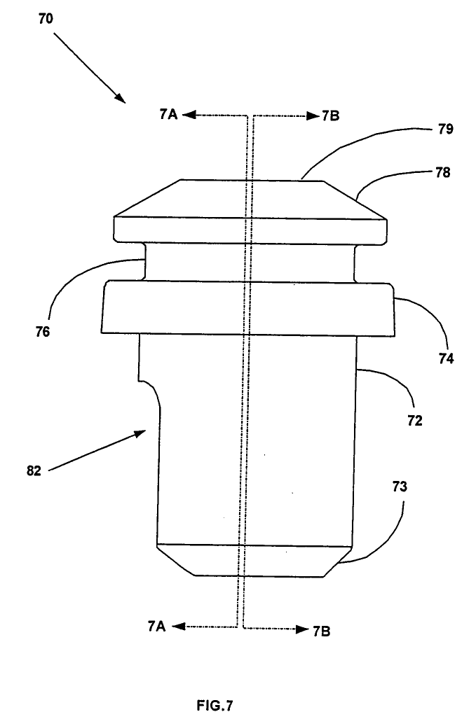

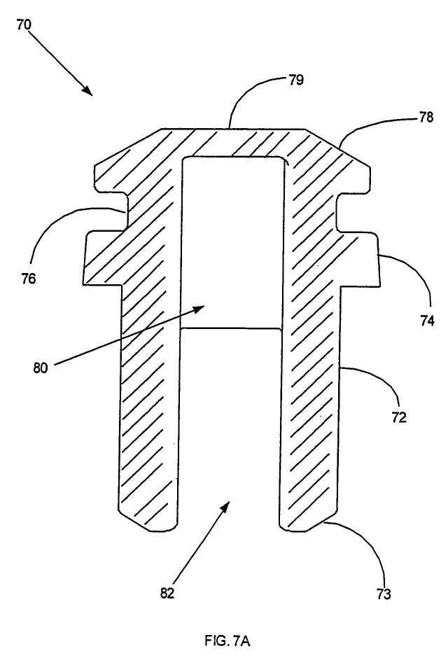

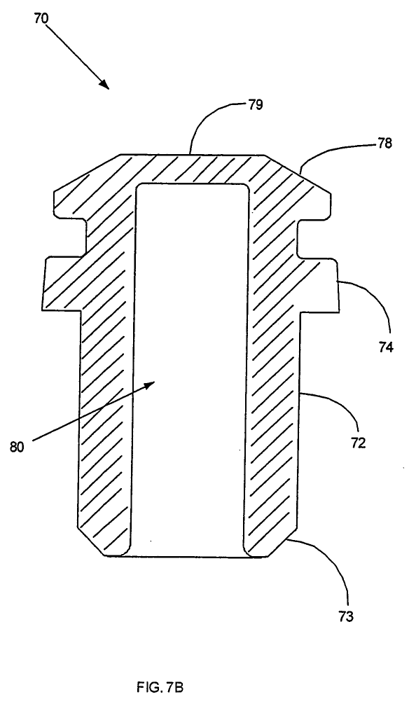

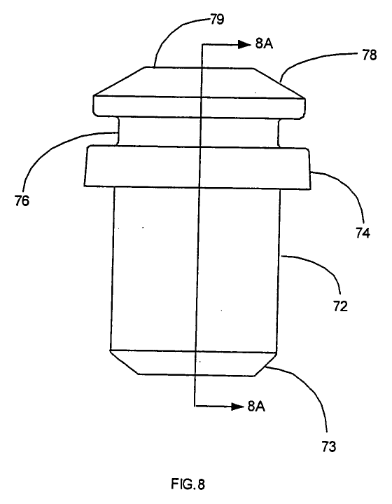

Groove 76 is essentially formed between ridge 74 and a flattened dome-shaped top 78, the dome-shaped top 78 having a flat 79 in its uppermost portion to facilitate closing after lyophilization is completed in an original manufacturing process. As described later in reference to FIGS. 6, 7A and 7B, trunk section 72 has an internal cylindrical open cavity 80 closed at its top by dome-shaped top 78. An important feature of the present invention is an opening 82 formed in a side portion 81 of trunk section 72 so that stopper 70 may be partly inserted into the upper portion of a vial 30V so that the vial's original liquid contents are exposed to vacuum during lyophilization in an original manufacturing process. Preferably, stopper 70 comprises a resealable elastomeric material selected from the group consisting of synthetic rubber, silicone rubber, thermoplastic elastomers and the like. In an advantageous embodiment, the overall height of stopper 70, from the bottom of trunk section 72 to the top of dome-shaped top 78 is generally twice as large as the diameter of trunk section 72, while in a preferred embodiment, the overall height of stopper 70 is about 0.6 inches, and the diameter of trunk section 72 is about 0.3 inches. In such an instance, ridge 74 has a diameter of about 0.4 inches and groove 76 is about 0.1 inches in height and about 0.1 inches in depth, internal cylindrical open cavity 80 being about 0.2 inches in diameter and 0.5 inches in height.

FIG. 7 is a side elevation view of stopper 70 showing how opening 82 is shaved out of the front of trunk section 72. FIG. 7 also shows groove 76 formed between top 78 and ridge 74 as well as the taper 73 in the outer bottom portion of trunk section 72. FIG. 7A is a section view of stopper 70 taken along line 7A-7A in FIG. 7 and more clearly illustrates how opening 82 is shaved out of the side of trunk section 72 with internal cylindrical open cavity 80 extending lengthwise through all of stopper 70 except being closed at the top by dome-shaped top 78. FIG. 7A also shows groove 76 formed between top 78 and ridge 74 and taper 73 in the outer bottom portion of trunk section 72. In an exemplary embodiment, the height of opening 82 is approximately one-half the height of the internal cavity and the width of the opening is approximately one-half the diameter of the trunk section 72. FIG. 7B is a section view of stopper 70 taken along line 7B-7B in FIG. 7 and more clearly illustrates the solid back of trunk section 72 with internal cylindrical open cavity 80 extending lengthwise through all of stopper 70.

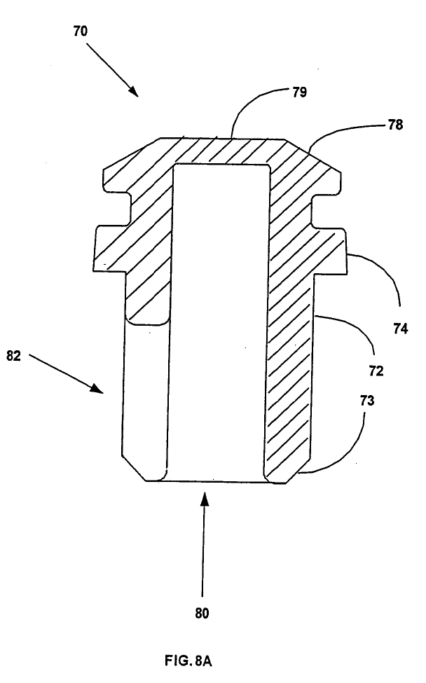

FIG. 8 is a rear elevation view of calibration and quality control solution vial stopper 70 and shows a solid trunk section 72, groove 76 formed between top 78 and ridge 74 as well as the taper 73 in the outer bottom portion of trunk section 72. FIG. 8A is a section view of stopper 70 taken along line 8A-8A in FIG. 8 and more clearly illustrates how opening 82 exposes the vial's original liquid contents to vacuum during lyophilization by means of internal cylindrical open cavity 80.

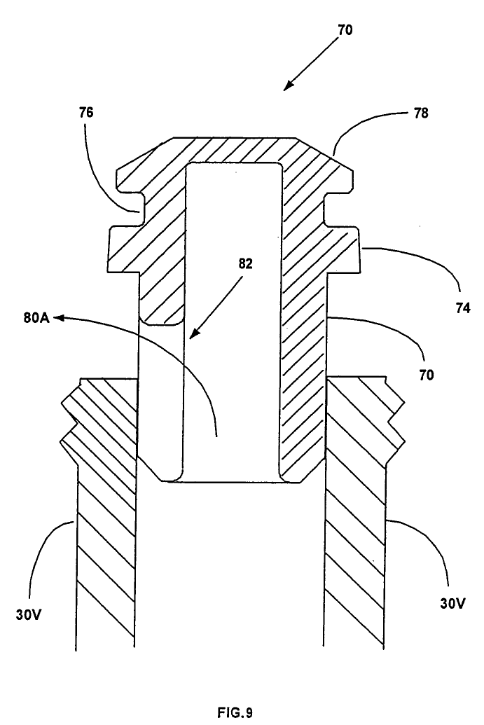

FIG. 9 is a section view of the calibration and quality control solution vial stopper 70 of FIG. 8 along line 8A-8A during a lyophilization process in which the contents of vial 30V are vacuum dried. Arrow 80A shows the venting of the interior of vial 30V through opening 82.

FIG. 10 is a section view of the calibration and quality control solution vial stopper of FIG. 8 along line 8A-8A including a fully secured conventional threaded cap 84 like seen in FIG. 10A, cap 84 having an opening 86 seen in FIG. 10B and sized to fit over dome-shaped top 78 of stopper 70 and slip into groove 76. Cap 84 is preferably threaded as shown so as to screw onto vial 30V, thereby securing stopper 70 to vial 30V.

As explained previously, stopper 70 is adapted for use in a manner that minimizes operation failure modes: (1) in an initial lyophilization manufacturing process; (2) by a user in a subsequent hydration process; (3) protecting contents of vial 30V stored on-board analyzer 10; (4) being punctured for aspiration; and, (5) re-sealing vial 30V after aspiration. Opening 82 in stopper 70's cylindrical lower trunk section 72 allows stopper 70 to be partly inserted into vial 30V so that the vial 30V's original liquid contents may be exposed to vacuum during a lyophilization operation. After the lyophilization process is completed, vial 30V may be closed. in an efficient manufacturing multiple-vial closing operation simply by vertically pushing downwards on an array of stoppers 70 until they are fully inserted into vials 30V. Subsequent to closing vials 30V, conventional threaded caps 84 may be attached to vials 30V by placing cap 84 with open hole 86 in cap 84 over dome-shaped top 78 of stopper 70 and twisting cap 84 over stopper 70 until the top portion 78 of stopper 70 squeezes through hole 86 and then expands to its original shape, so that cap 84 slips into groove 76, thereby securing cap 84 and stopper 70 together in combination. Prior to the lyophilized calibration solution being used on analyzer 10, an operator unscrews the cap 84 and stopper 70 combination, hydrates the chemicals as required, replaces the cap 84 and stopper 70 combination, mixes as required, and places calibration vial 30V on-board analyzer 10. The open hole 86 in cap 84 exposes a central portion of stopper 70 through which an aspiration probe can puncture during an aspiration process. Stopper 70 is made of an elastomeric material that reseals the puncture to protect the contents of vial 30V while it remains stored in inventory upon analyzer 10. A key feature of the cap 84 and stopper 70 combination is the securing groove 76 that effectively integrates cap 84 and stopper 70 together so that operator errors arising from the failure to properly replace and secure stopper 70 onto calibration vial 30V after hydration are minimized.

It should be readily understood by those persons skilled in the art that the present invention is susceptible of a broad utility and-application. Many embodiments and adaptations of the present invention other than those herein described, as well as many variations, modifications and equivalent arrangements will be apparent from or reasonably suggested by the present invention and the foregoing description thereof, without departing from the substance or scope of the present invention.

Accordingly, while the present invention has been described herein in detail in relation to specific embodiments, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

We claim:

1. A stopper adapted for use in an automated clinical analyzer, the stopper having a generally vertically elongate shape with a cylindrical trunk section, the trunk section having an internal cylindrical cavity closed at the top by a top portion, the trunk also having an opening formed in a side portion of the trunk section.

2. The stopper of claim 1 wherein the height of the opening is approximately one-half the height of the internal cavity and the width of the opening is approximately one-half the diameter of the trunk section.

3. The stopper of claim 1 wherein a circular ridge is formed near the top of the trunk section and a groove is formed between the circular ridge and said top portion.

4. The stopper of claim 1 wherein the top portion is a dome-shaped top portion with a flat in its upper surface.

5. The stopper of claim 2 wherein the groove is sized to receive a center hole in the top of a threaded cap.

6. The stopper of claim 3 wherein the ridge is sized to prevent the stopper from being fully inserted into a vial.

7. The stopper of claim 1 wherein the bottom portion of trunk section is sloped slightly inwards forming a taper.

8. The stopper of claim 1 wherein the stopper comprises a resealable elastomeric material selected from the group consisting of synthetic rubber, silicone rubber, and thermoplastic elastomers.

9. The stopper of claim 1 in combination with a threaded cap with a top, the cap having a hole in the top sized so that the top portion of the stopper may be squeezed through hole thereby securing the cap and the stopper together in combination.
